(19) United States
(12) Patent Application Publication
(10) Pub. No.: US 2010/0121966 A1
(43) Pub. Date: May 13, 2010

(54) REPEATER AND REPEATING METHOD THEREOF

(75) Inventors: Yoshinobu FUJIWARA, Tokyo (JP); Masahiko MAWATARI, Kanagawa (JP); Kunio HONSAWA, Tokyo (JP); Tatsuyuki MATSUSHITA, Tokyo (JP); Taku KATO, Kanagawa (JP); Hiroshi ISOZAKI, Kanagawa (JP); Atsushi NAKAJIMA, Tokyo (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/492,432

(22) Filed: Jun. 26, 2009

(30) Foreign Application Priority Data
Nov. 7, 2008 (JP) 2008-287189

(51) Int. Cl. G06F 15/16

(52) U.S. Cl. 709/229

(57) ABSTRACT

According to one embodiment, a repeater receives content data from a sender device through a first content protection technology and transmits the content data to another device through a second content protection technology. The repeater includes a receiver, a preparation module, and a transmitter. The receiver receives identification information that identifies a device compliant with the second content protection technology through the second content protection technology. The preparation module prepares an identification information list based on the first content protection technology that contains the identification information based on the second content protection technology received by the receiver and identification information based on the first content protection technology that identifies the repeater. The transmitter transmits the identification information list to the sender device through the first content protection technology.

### CROSS-REFERENCE TO RELATED APPLICATIONS

This application is based upon and claims the benefit of priority from Japanese Patent Application No. 2008-287189, filed Nov. 7, 2008, the entire contents of which are incorporated herein by reference.

### BACKGROUND OF THE INVENTION

1. Field

One embodiment of the invention relates to a repeater that relays content data protected by copyright, and a repeating method thereof.

2. Description of the Related Art

In recent years, with improvements in such technologies as compression coding, encryption, and communication, movies and music are digitalized into content data and such content data is communicated via a network. Content data of this type is often protected by copyright. Accordingly, there has been proposed various technologies for eliminating unauthorized devices that are highly likely to infringe copyright by, for example, making an illegal copy of protected content.

According to digital transmission content protection (DTCP), before communication of content data between devices connected to each other, the devices are authenticated based on identification information that identifies DTCP devices. If the authentication is successful, encrypted content data is communicated between the devices. With this, content data can be communicated only between authorized devices capable of valid communication of content data. Reference may be had to, for example, Digital Transmission Content Protection Specification Revision 1.51 (Informational Version), pp. 55 to 64, Chapter 8, AV/C Digital Interface Command Set Extensions.

Similarly, according to high-bandwidth digital content protection (HDCP), before communication of content data between devices connected to each other, the devices are authenticated based on identification information that identifies HDCP devices. If the authentication is successful, encrypted content data is communicated between the devices.

In the HDCP scheme, it is not possible to communicate identification information that identifies devices complying with other copyright protection schemes (such as DTCP). For example, it is assumed that a pair of repeaters compliant with DTCP relay communication of content data protected by HDCP between devices. In this case, even if a repeater on the receiving side is an unauthenticated device, identification information that identifies the repeater cannot be sent to the transmitting side, and therefore the repeater cannot be removed. Consequently, the transmitter device cannot be prevented from transmitting the content data to the unauthenticated device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a content transfer system including a repeater, a source device, and a sink device according to an embodiment of the invention;

FIG. 2 is an exemplary flowchart of a list creation process performed by the repeater in the embodiment;

FIG. 3 is an exemplary flowchart of an authentication process performed by the source device in the embodiment;

FIG. 4 is an exemplary block diagram of a hardware configuration of the repeater in the embodiment; and

FIG. 5 is an exemplary block diagram of a hardware configuration of the source device and the sink device in the embodiment.

### DETAILED DESCRIPTION

Various embodiments according to the invention will be described hereinafter with reference to the accompanying drawings. In general, according to one embodiment of the invention, a repeater receives content data from a sender device through a first content protection technology and transmits the content data to another device through a second content protection technology. The repeater comprises a receiver, a preparation module, and a transmitter. The receiver is configured to receive identification information that identifies a device compliant with the second content protection technology through the second content protection technology. The preparation module is configured to prepare an identification information list based on the first content protection technology that contains the identification information based on the second content protection technology received by the receiver and identification information based on the first content protection technology that identifies the repeater. The transmitter is configured to transmit the identification information list to the sender device through the first content protection technology.

According to another embodiment of the invention, a repeating method is applied to a repeater that receives content data from a sender device through a first content protection technology and transmits the content data to another device through a second content protection technology. The repeating method comprises: a receiver receiving identification information that identifies a device compliant with the second content protection technology through the second content protection technology; a preparation module preparing an identification information list based on the first content protection technology that contains the identification information based on the second content protection technology received by the receiver and identification information based on the first content protection technology that identifies the repeater; and a transmitter transmitting the identification information list to the sender device through the first content protection technology.

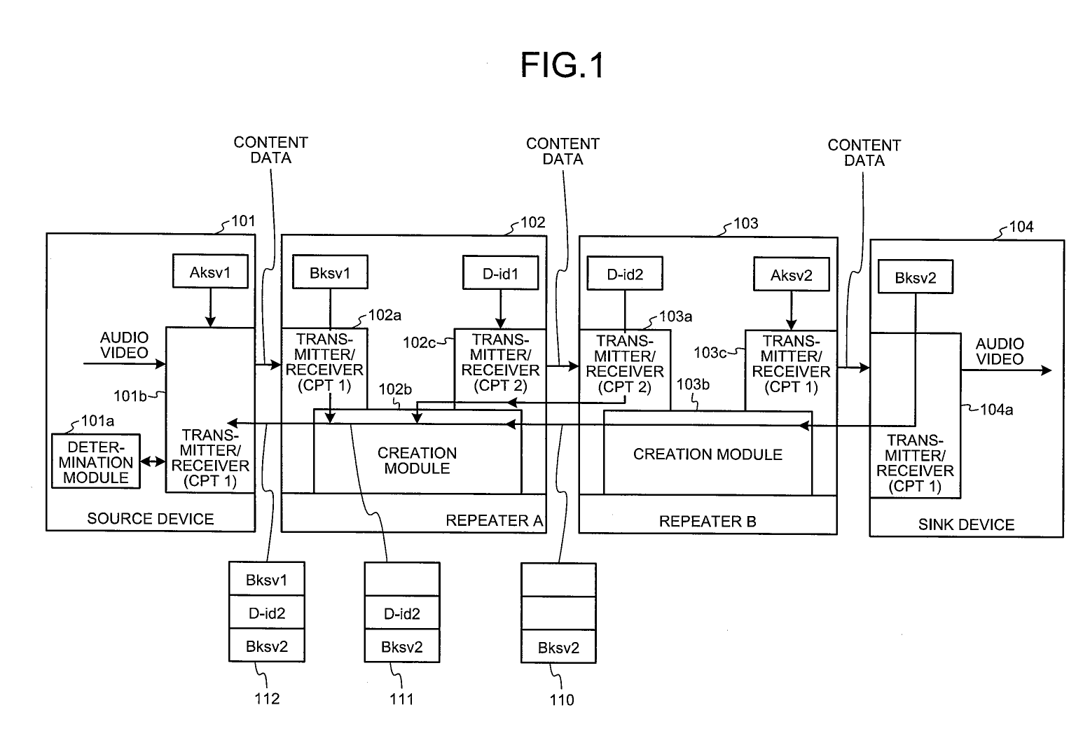

With reference to FIG. 1, a description will be given of a content transfer system including repeaters, a source device, and a sink device according to an embodiment of the invention. Although the embodiment describes the case where the repeaters, such as wireless local area network (LAN) routers, relay communication between the source device and the sink device such as personal computers, this is by way of example and not by way of limitation. For example, the repeaters may relay communication of content data between AV devices (for example, a hard disk recorder and a digital television, or the like) connected therethrough to each other. FIG. 1 is a block diagram of a content transfer system 100 including a repeater A 102, a repeater B 103, a source device 101, and a sink device 104 according to the embodiment.

The content transfer system 100 comprises the source device 101, the sink device 104, the repeater A 102, and the repeater B 103. The source device 101 transmits content data such as video data and audio data. The sink device 104 receives the content data transmitted from the source device 101. The repeater A 102 and the repeater B 103 relay the content data between the source device 101 and the sink device 104. It is assumed herein that the source device 101 and the repeater A 102 are connected by a wired network such as a high-definition multimedia interface (HDMI), and similarly, that the sink device 104 and the repeater B 103 are connected by a wired network. It is also assumed herein that the repeater A 102 and the repeater B 103 are connected by a wireless network such as Wi-Fi.

Described below is a configuration of the sink device 104. The sink device 104 receives from the repeater B 103 content data protected by high-bandwidth digital content protection (HDCP), which is a first content protection technology (CPT 1).

The sink device 104 comprises a transmitter/receiver (CPT 1) 104a.

The transmitter/receiver 104a is an interface to the repeater B 103 and is compliant with HDCP, i.e., an interface with CPT 1 for communication with the repeater B 103. Through the wired network that connects between the sink device 104 and the repeater B 103, the transmitter/receiver 104a receives content data protected by CPT 1 from the repeater B 103.

Before receiving the content data, the transmitter/receiver 104a transmits identification information (Bksv2) based on CPT 1, which uniquely identifies the sink device 104, to the repeater B 103 through CPT 1. Upon transmitting the identification information (Bksv2) to the repeater B 103, the transmitter/receiver 104a may encrypt the identification information (Bksv2) and transmit the encrypted identification information (Bksv2) to the repeater B 103. Alternatively, the transmitter/receiver 104a may transmit the identification information (Bksv2) to the repeater B 103 with an electronic signature to verify the identification information (Bksv2).

Described below is a configuration of the repeater B 103. The repeater B 103 transfers content data to the sink device 104 through CPT 1. The content data is protected by digital transmission content protection (DTCP) or digital transmission content protection-internet protocol (DTCP-IP), which is a second content protection technology (CPT 2).

The repeater B 103 comprises a transmitter/receiver (CPT 2) 103a, a creation module 103b, and a transmitter/receiver (CPT 1) 103c.

The transmitter/receiver 103c is an interface to the sink device 104 and is compliant with HDCP, i.e., an interface with CPT 1 for communication with the sink device 104. Through the wired network that connects between the repeater B 103 and the sink device 104, the transmitter/receiver 103c transmits content data protected by CPT 1 to the sink device 104.

Before transmitting the content data, the transmitter/receiver 103c receives the identification information (Bksv2) based on CPT 1, which uniquely identifies the sink device 104, from the sink device 104 through CPT 1.

When the identification information (Bksv2) received from the sink device 104 is contained in an unauthorized device list stored in a storage medium that the repeater B 103 is provided with, the transmitter/receiver 103c does not transmit the content data to the sink device 104. However, the embodiment is not so limited. For example, the repeater B 103 may not necessarily have the function of terminating transmission of content data if at least the source device 101 has that function. In this case, when a list 112, which will be described later, received from the repeater A 102 contains identification information that matches the one contained in the unauthorized device list, the source device 101 terminates transmission of content data.

The creation module 103b prepares a list 110 that contains the identification information (Bksv2) received by the transmitter/receiver 103c.

The transmitter/receiver 103a is an interface to the repeater A 102 and is compliant with DTCP, i.e., an interface with CPT 2 for communication with the repeater A 102. Through the wireless network that connects between the repeater A 102 and the repeater B 103, the transmitter/receiver 103a receives content data protected by CPT 2 from the repeater A 102.

Before receiving the content data, the transmitter/receiver 103a transmits the list 110 created by the creation module 103b and identification information (D-id2) based on CPT 2, which uniquely identifies the repeater B 103, to the repeater A 102 through CPT 2. The transmitter/receiver 103a may be capable of receiving from the repeater A 102 a list (not illustrated) that contains identification information (Aksvl) based on CPT 1, which uniquely identifies the source device 101, and identification information (D-id1) based on CPT 2, which uniquely identifies the repeater A 102.

Upon transmitting the list 110 and the identification information (D-id2) to the repeater A 102, the transmitter/receiver 103a may encrypt the list 110 and the identification information (D-id2) and transmit the encrypted list 110 and identification information (D-id2) to the repeater A 102. Alternatively, the transmitter/receiver 103a may transmit the list 110 and the identification information (D-id2) with an electronic signature to verify the list 110 and the identification information (D-id2).

Described below is a configuration of the repeater A 102. The repeater A 102 receives content data protected by CPT 1 from the source device 101, and transfers the content data to the repeater B 103 through CPT 2.

The repeater A 102 comprises a transmitter/receiver (CPT 1) 102a, a creation module 102b, and a transmitter/receiver (CPT 2) 102c.

The transmitter/receiver 102c is an interface to the repeater B 103 and is compliant with DTCP, i.e., an interface with CPT 2 for communication with the repeater B 103. Through the wireless network that connects between the repeater A 102 and the repeater B 103, the transmitter/receiver 102c transmits content data protected by CPT 2 to the repeater B 103.

Before transmitting the content data, the transmitter/receiver 102c receives the identification information (D-id2) based on CPT 2 unique to the repeater B 103 and the list 110 from the repeater B 103 through CPT 2. The list 110 contains the identification information (Bksv2) based on CPT 1 unique to the sink device 104. The transmitter/receiver 102c may be capable of transmitting identification information (D-id1) based on CPT 2, which uniquely identifies the repeater A 102, to the repeater B 103 through CPT 2.

When any of the identification information (Bksv2) contained in the list 110 and the identification information (D-id2) received from the repeater B 103 matches the one contained in an unauthorized device list stored in a storage medium that the repeater A 102 is provided with, the transmitter/receiver 102c does not transmit the content data to the repeater B 103. However, the embodiment is not so limited. For example, the repeater A 102 may not necessarily have the function of terminating transmission of content data if at least the source device 101 has that function. In this case, when the list 112, which will be described later, received from the repeater A 102 contains identification information that matches the one contained in the unauthorized device list, the source device 101 terminates transmission of content data.

The creation module 102b creates the list 112 based on CPT 1. More specifically, the creation module 102b adds identification information (Bskv1) based on CPT 1, which uniquely identifies the repeater A 102, to a list 111 that contains the identification information (Bksv2) contained in the list 110 and the identification information (D-id2) received by the transmitter/receiver 102c to create the list 112.

The transmitter/receiver 102a is an interface to the source device 101 and is compliant with HDCP, i.e., an interface with CPT 1 for communication with the source device 101. Through the wired network that connects between the source device 101 and the repeater A 102, the transmitter/receiver 102a receives content data protected by CPT 1 from the source device 101.

Before receiving the content data, the transmitter/receiver 102a transmits the list 112 created by the creation module 102b to the source device 101 through CPT 1. Upon transmitting the list 112 created by the creation module 102b to the source device 101, the transmitter/receiver 102a may encrypt the list 112 and transmit the encrypted list 112 to the source device 101. Alternatively, the transmitter/receiver 102a may transmit the list 112 with an electronic signature to verify the list 112.

Described below is a configuration of the source device 101. The source device 101 transmits content data protected by CPT 1 to the repeater A 102.

The source device 101 comprises a determination module 101a and a transmitter/receiver (CPT 1) 101b.

The transmitter/receiver 101b is an interface to the repeater A 102 and is compliant with HDCP, i.e., an interface with CPT 1 for communication with the repeater A 102. Through the wired network that connects between the source device 101 and the repeater A 102, the transmitter/receiver 101b transmits content data protected by CPT 1 to the repeater A 102.

Before transmitting the content data, the transmitter/receiver 101b receives the list 112 from the repeater A 102 through CPT 1.

The determination module 101a determines whether any of identification information (Bksv1, D-id2, and Bksv2) contained in the list 112 received by the transmitter/receiver 101b matches the one contained in an unauthorized device list stored in a storage medium that the source device 101 is provided with.

When the determination module 101a determines that none of the identification information (Bksv1, D-id2, and Bksv2) contained in the list 112 matches the one contained in the unauthorized device list, the transmitter/receiver 101b transmits the content data protected by CPT 1.

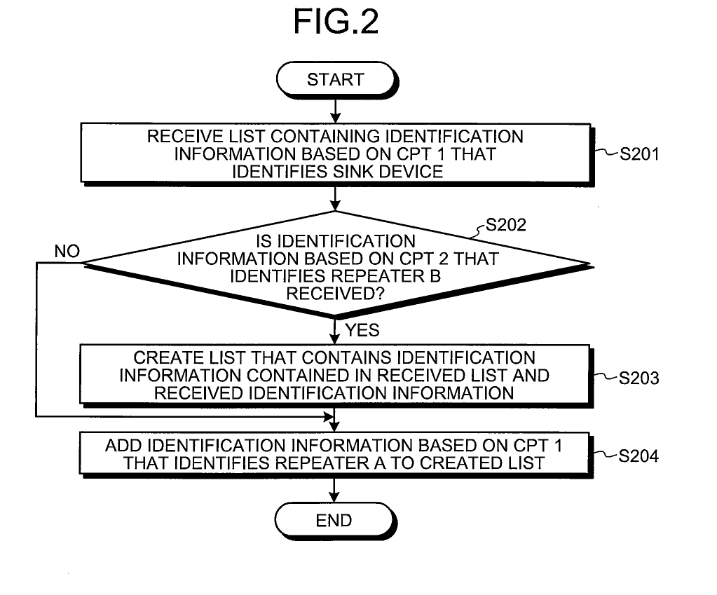

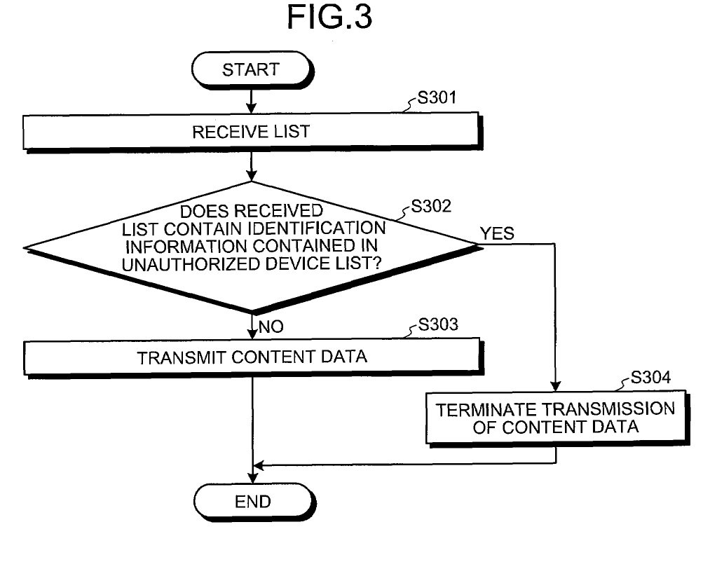

With reference to FIG. 2, a description will now be given of the process of creating the list 111 performed by the repeater A 102. Incidentally, the repeater B 103 creates the list 110 in the same manner as the repeater A 102 creates the list 111, and the description will not be repeated. Further, with reference to FIG. 3, a description will be given of an authentication process performed by the source device 101. FIG. 2 is a flowchart of the list creation process performed by the repeater A 102. FIG. 3 is a flowchart of the authentication process performed by the source device 101.

First, the list creation process performed by the repeater A 102 will be described with reference to FIG. 2. Before transmitting content data, the transmitter/receiver 102c receives the list 110 from the repeater B 103 through CPT 2 (S201) The list 110 contains the identification information (Bksv2) based on CPT 1 that identifies the sink device 104. When the transmitter/receiver 102c receives the identification information (D-id2) based on CPT 2 that identifies the repeater B 103 from the repeater B 103 through CPT 2 (Yes at S202), the creation module 102b creates the list 111 that contains the identification information (Bksv2) contained in the list 110 and the identification information (D-id2) received by the transmitter/receiver 102c (S203).

On the other hand, when the transmitter/receiver 102c does not receive the identification information (D-id2) based on CPT 2 that identifies the repeater B 103 (No at S202), the creation module 102b add the identification information (Bskv1) based on CPT 1 that identifies the repeater A 102 to the list 110 or the list 111 to create the list 112 based on CPT 1 (S204). Besides, after creating the list 111 (S203), the creation module 102b also creates the list 112 that further contains the identification information (Bksv1) identifying the repeater A 102 (S204).

Next, the authentication process performed by the source device 101 will be described with reference to FIG. 3. Before transmitting content data, the transmitter/receiver 101b receives the list 112 from the repeater A 102 through CPT 1 (S301). Thereafter, the determination module 101a determines whether any of identification information (Bksv1, D-id2, and Bksv2) contained in the list 112 received by the transmitter/receiver 101b matches the one contained in the unauthorized device list stored in the storage medium that the source device 101 is provided with (S302) When it is determined that none of the identification information (Bksv1, D-id2, and Bksv2) contained in the list 112 matches the one contained in the unauthorized device list (No at S301), the transmitter/receiver 101b transmits the content data protected by CPT 1 to the repeater A 102 (S303). On the other hand, when it is determined that any of the identification information (Bksv1, D-id2, and Bksv2) contained in the list 112 matches the one contained in the unauthorized device list (Yes at S301), the transmitter/receiver 101b terminates transmission of the content data (S304).

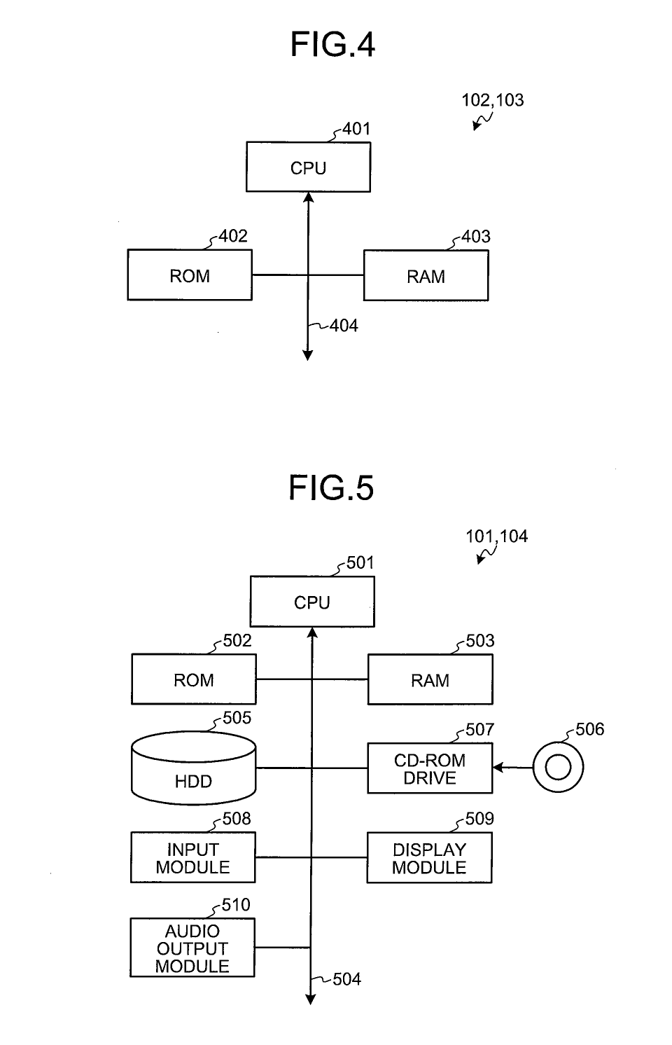

With reference to FIG. 4, a description will then be given of a hardware configuration of the repeater A 102 and the repeater B 103 of the embodiment. FIG. 4 is a block diagram of the hardware configuration of the repeater A 102 and the repeater B 103.

As illustrated in FIG. 4, the repeater A 102 and the repeater B 103 may be, for example, wireless LAN routers and each comprise a central processing unit (CPU) 401. The CPU 401 is the main element of the wireless LAN router and controls the constituent elements thereof. The repeater A 102 and the repeater B 103 each further comprise a read only memory (ROM) 402 and a random access memory (RAM) 403, which are connected to the CPU 401 via a bus 404. The ROM 402 stores BIOS and the like, while the RAM 403 is rewritable and stores various types of data.

Since the RAM 403 stores various types of data in a rewritable manner, it provides a work area to the CPU 401 and functions as a buffer or the like.

The ROM 402 stores an operating system (OS) and various programs. The programs may run on the OS and, in this case, the OS may perform part of various types of processing implemented by the programs. Further, the programs may be stored as part of a group of program files that constitutes predetermined application software, the OS, or the like.

The ROM 402 also stores the identification information based on CPT 1 that identifies the repeater (the repeater A 102 or the repeater B 103) as well as the identification information based on CPT 2 that identifies the repeater. It is assumed herein that the identification information based on CPT 1 and that based on CPT 2 have the same data length.

The CPU 401 controls the overall operation of the system, and performs various types of processing based on the programs stored in the ROM 402 used as the main storage device of the system.

According to the various programs stored in the ROM 402, the creation module 102b and the creation module 103b are implemented on the repeater A 102 and the repeater B 103, respectively.

With reference to FIG. 5, a description will then be given of a hardware configuration of the source device 101 and the sink device 104 of the embodiment. FIG. 5 is a block diagram of the hardware configuration of the source device 101 and the sink device 104.

As illustrated in FIG. 5, the source device 101 and the sink device 104 may be, for example, personal computers and each comprise a CPU 501. The CPU 501 is the main element of the personal computer and controls the constituent elements thereof. The source device 101 and the sink device 104 each further comprise a ROM 502 and a RAM 503, which are connected to the CPU 501 via a bus 504. The ROM 502 stores BIOS and the like, while the RAM 503 is rewritable and stores various types of data.

The source device 101 and the sink device 104 each further comprise a hard disk drive (HDD) 505, a compact disc read only memory (CD-ROM) 506, a CD-ROM drive 507, an input module 508, a display module 509, and an audio output module 510. The HDD 505 stores various programs and content data including audio data and video data. The CD-ROM 506 stores computer software which is a distributed program. The CD-ROM drive 507 reads the computer software from the CD-ROM 506. The input module 508 includes a keyboard, a mouse, and the like used to provide various instructions. The display module 509 includes a cathode ray tube (CRT) or a liquid crystal display (LCD) to display various types of video data. The audio output module 510 includes a speaker for outputting audio data and a headphone. The above modules are also connected to the bus 504 via an I/O (not illustrated).

Since the RAM 503 stores various types of data in a rewritable manner, it provides a work area to the CPU 501 and functions as a buffer or the like. The RAM 503 also stores the identification information based on CPT 1 that identifies the device (the source device 101 or the sink device 104).

The CD-ROM 506 stores an OS and various programs. Besides, the CD-ROM 506 of the source device 101 stores the unauthorized device list that contains identification information identifying an unauthorized device based on CPT 1 and also identification information identifying an unauthorized device based on CPT 2. The CD-ROM drive 507 reads the programs and the unauthorized device list from the CD-ROM 506 under the control of the CPU 501. Then, the programs and the unauthorized device list are installed on the HDD 505.

While the CD-ROM 506 is cited above as an example of a storage medium of the embodiment, the storage medium may be of different types. Examples of the storage medium of the embodiment include various types of optical disks such as a digital versatile disk (DVD), various types of magneto-optical discs, various types of magnetic disks such as a flexible disk, and semiconductor memory. Alternatively, the programs and the unauthorized device list may be downloaded via a network (not illustrated) and installed on the HDD 505. In this case, a sender server that stores the programs and the unauthorized device list can be regarded as the storage medium of the embodiment. Incidentally, the programs may run on a predetermined OS and, in this case, the OS may perform part of various types of processing implemented by the programs. Further, the programs may be stored as part of a group of program files that constitutes predetermined application software, the OS, or the like.

The CPU 501 controls the overall operation of the system, and performs various types of processing based on the programs loaded into the HDD 505 used as the main storage device of the system. According to the programs installed on the HDD 505, the source device 101 implements the determination module 101a.

As described above, according to the embodiment, the repeater A 102 can authenticate a device connected via the repeater A 102 to the source device 101 using the unauthorized device list stored in the source device 101 regardless of the type of content protection technology. Thus, content data can be reliably prevented from being transmitted to an unauthorized device connected via the repeater A 102 to the source device 101.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A repeater that receives content data from a sender device with a first content protection technology and transmits the content data to another device with a second content protection technology, the repeater comprising:
a receiver configured to receive identification information that identifies a device compliant with the second content protection technology with the second content protection technology;
a preparation module configured to prepare an identification information list of the first content protection technology, the identification information list containing the identification information of the second content protection technology received by the receiver and identification information of the first content protection technology that identifies the repeater; and
a transmitter configured to transmit the identification information list to the sender device with the first content protection technology.

2. The information providing server of claim 1, wherein
the receiver is configured to receive identification information with the second content protection technology, the identification information identifying a device compliant with the first content protection technology, and
the preparation module is configured to prepare the identification information list based on the first content protection technology that contains the identification information of the first content protection technology and the identification information of the second content protection technology received by the receiver.

3. The information providing server of claim 1, wherein a data length of the identification information of the first content protection technology is equal to a data length of the identification information of the second content protection technology.

4. The information providing server of claim 1, wherein the transmitter is configured to encrypt the identification information list and transmit the encrypted identification information list to the sender device.

5. The information providing server of claim 1, wherein the transmitter is configured to transmit the identification information list to the sender device with an electronic signature to verify the identification information list.

6. A repeating method applied to a repeater that receives content data from a sender device with a first content protection technology and transmits the content data to another device with a second content protection technology, the repeating method comprising:
a receiver receiving identification information that identifies a device compliant with the second content protection technology with the second content protection technology;
a preparation module preparing an identification information list based on the first content protection technology, the identification information list containing the identification information of the second content protection technology received by the receiver and identification information of the first content protection technology that identifies the repeater; and
a transmitter transmitting the identification information list to the sender device with the first content protection technology.
